(19) United States
(12) Patent Application Publication
(10) Pub. No.: US 2009/0106358 A1
(43) Pub. Date: Apr. 23, 2009

(54) CACHE CONTROL PROGRAM, STORAGE MEDIUM STORING CACHE CONTROL PROGRAM, AND CACHE CONTROL APPARATUS

(75) Inventors: Madoka Mitsuoka, Kawasaki (JP); Masatomo Yasaki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/256,237

(22) Filed: Oct. 22, 2008

(30) Foreign Application Priority Data
Oct. 23, 2007 (JP) 2007-275096

(51) Int. Cl. G06F 15/16

(52) U.S. Cl. 709/203

(57) ABSTRACT

A storage medium stores a cache control program which causes a computer to execute receiving a feed that concerns any desired site. The computer judges whether or not a rich content specified from the feed among contents stored in a first server is cached, on the basis of the number of subscribers to the feed received, and transmits a cache instruction for the rich content to a second server that accepts a transmission request for the rich content from a terminal apparatus of the subscriber, in a case where the rich content needs to be cached.

### CROSS-REFERENCE TO RELATED APPLICATIONS

This application is based upon and claims the benefit of priority from the prior Japanese Patent Application No. 2007-275096 filed on Oct. 23, 2007, the entire contents of which are incorporated herein by reference.

### BACKGROUND

### Field

This invention relates to a storage medium storing a cache control program which controls the caching of images, music and the like contents delivered on a network, and a cache control apparatus.

### SUMMARY

According to an aspect of the present invention, there is provided a storage medium storing a cache control program which causes a computer to execute: receiving a feed that concerns any desired site; judging whether or not a rich content specified from the feed among contents stored in a first server is cached, on the basis of the number of subscribers to the feed received; and transmitting a cache instruction for the rich content, to a second server that accepts a transmission request for the rich content from a terminal apparatus of the subscriber, in a case where the rich content needs to be cached.

Additional objects and advantages of the invention will be set forth in part in the description which follows, and in part will be obvious from the description, or may be learned by practice of the invention. The object and advantageous of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a system configurational diagram of a content delivery system according to an embodiment of this invention;

FIG. 2 is an explanatory diagram showing the stored contents of databases which are included in a cache control apparatus;

FIG. 3 is an explanatory diagram showing the stored contents of a cache information database (DB) which is included in a content server;

FIG. 4 is an explanatory diagram showing the hardware configuration of a computer apparatus according to an embodiment of this invention;

FIG. 5 is a block diagram showing the functional configuration of the content delivery system;

FIG. 6 is an explanatory diagram showing a practicable example of a feed;

FIG. 7 is a flow chart showing the procedure of the cache control process of the cache control apparatus according to an embodiment of this invention;

FIG. 8 is a flow chart showing an example of the processing procedure of a judgment process;

FIG. 9 is a flow chart showing an example of the processing procedure of a transmission process;

FIG. 10 is a flow chart showing an example of the procedure of the deletion process of a cache server according to an embodiment of this invention; and

FIG. 11 is an explanatory diagram showing another system configuration of the content delivery system.

### DETAILED DESCRIPTION OF THE EMBODIMENTS

In recent years, services which deliver videos, flashes and similar content on networks have been expanded. However, due to the delivery of the contents of large data quantity, the traffic on a network band and the increase of a load on a delivery server have caused the quality of the service to be degraded.

In this regard, there has been adopted a technique wherein a cache server is arranged in the network of an Internet service provider (ISP), and the contents are cached in the cache server beforehand. Alternatively, there has been adopted a technique wherein the content viewed by a certain user is cached into the cache server in preparation for the view of another user. For the effective utilization of the cache server, it is necessary to accurately predict the contents which will be viewed by many users, and to cache them into the cache server.

There has hitherto been disclosed a scheme wherein the caching of the contents is controlled on the basis of a delivery URL list in which the URLs of the contents to be delivered are listed up (see, for example, JP-A-2001-92745 being “Patent Document 1”). The delivery URL list is created on the basis of a prediction based on the access logs of Web sites, a human analysis, or Web sites linked to a portal site.

With the prior-art technique stated in Patent Document 1, however, it has been difficult to accurately predict accesses to spontaneous contents such as videos photographed by general users that are submitted to a video sharing site or the like. The accesses to the video sometimes increase suddenly if, for example, the submitted video has been introduced in the blog of an entertainer, or the like. In such a case, accesses to the delivery server of the video increase significantly in a short time, and traffic on the network band or an increase of the load on the delivery server occur. As a result, the quality of the service is degraded.

Besides, even when the contents have been cached into the cache server on the basis of the result of the prediction, a time zone in which the accesses to the contents are concentrated might overlap a time zone in which other communication traffic within the network increases. In such a case, the traffic in the network band occurs and the quality of the service is degraded.

Now, the preferred embodiments of a storage medium storing a cache control program, a cache control apparatus, and a cache control method will be described in detail with reference to the accompanying drawings.

### (System Configuration of Content Delivery System)

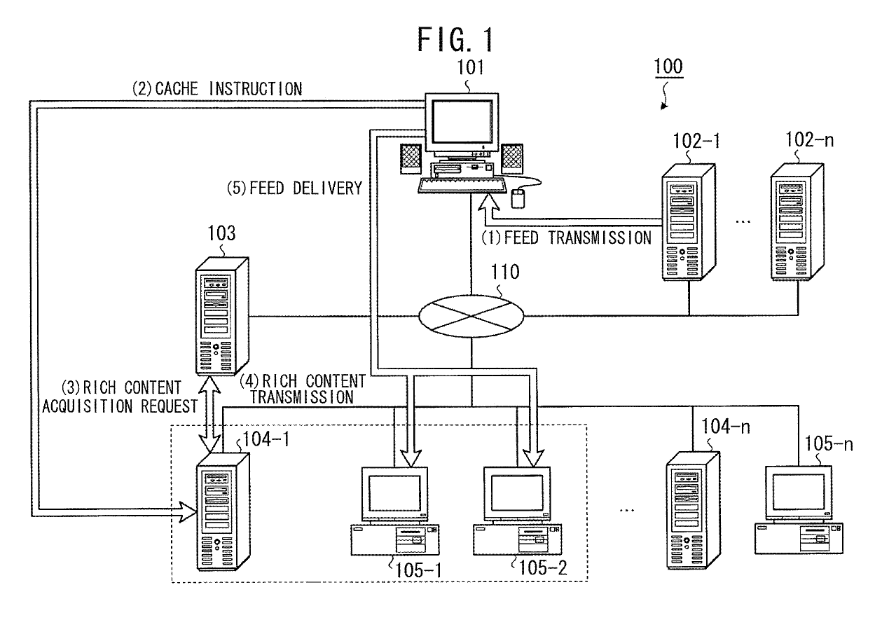

First, the system configuration of a content delivery system according to one embodiment of this invention will be described. FIG. 1 is a system configurational diagram of the content delivery system according to this invention. Referring to FIG. 1, a content delivery system 100 is such that a cache control apparatus 101, Web servers 102-1 to 102-n, a content server 103, cache servers 104-1 to 104-n, and client terminals 105-1 to 105-n are connected through a network 110 such as the Internet, a LAN or a WAN, in a manner to be communicable with one another.

The content delivery system 100 provides on the network 110 a service in which content such as images, music and the like are delivered to the client terminals 105-1 to 105-n. The content delivery system 100 includes a contrivance in which feeds representing the summaries of Web sites are respectively delivered to the client terminals 105-1 to 105-n of users who subscribe to the feeds (hereinbelow, termed the “subscribers”).

The cache control apparatus 101 is a computer apparatus which has the function of controlling the caching of rich contents into the cache servers 104-1 to 104-n. The cache control apparatus 101 also has the function of receiving feeds from the Web servers 102-1 to 102-n and then delivering the feeds to the client terminals 105-1 to 105-n of the subscribers.

Each of the Web servers 102-1 to 102-n is a computer apparatus which has the function of creating the feed from a content (for example, an HTML document) stored in a storage unit. Besides, each of the Web servers 102-1 to 102-n has the function of transmitting the feed to the cache control apparatus 101 in compliance with a request from this cache control apparatus 101.

The content server 103 is a computer apparatus which has the function of transmitting rich contents stored in a storage unit, to the respective cache servers 104-1 to 104-n in compliance with requests from these cache servers 104-1 to 104-n.

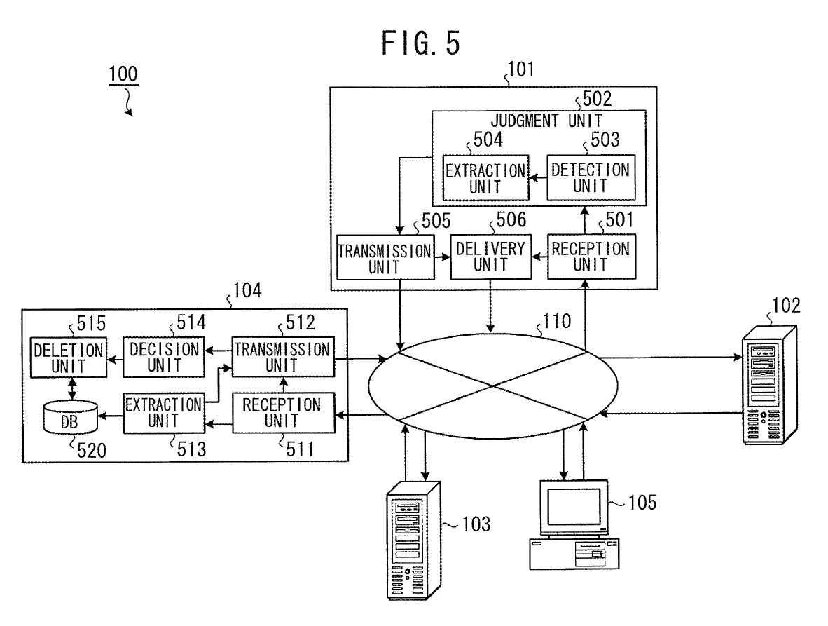

Each of the cache servers 104-1 to 104-n is a computer apparatus which has the function of caching the rich content into a cache DB 520 to be described later (refer to FIG. 5), in compliance with a cache instruction from the cache control apparatus 101. More specifically, a request for acquiring the rich content specified from the cache instruction is transmitted to the content server 103, with the result that the rich content transmitted in is cached into the cache DB 520.

Here, the cache servers 104-1 to 104-n are respectively prepared for individual Internet service providers (hereinbelow, termed the “ISPs”) which provide Internet services. By way of example, the cache server 104-1 is a server which is operated by the ISP whose ISP name is “mifty”.

Each of the client terminals 105-1 to 105-n is a computer apparatus which has the function of receiving the feed delivered from the cache control apparatus 101. The client terminals 105-1 to 105-n can utilize the Internet services provided by the ISPs with which the users have made contracts.

In this embodiment, on the supposition that accesses to videos and the like increase when spontaneous contents are submitted to a video sharing site or the like, the rich contents specified from feeds having a large number of subscribers are cached into the cache servers 104-1 to 104-n beforehand. That is, the rich contents as to which future increases in the number of accesses are anticipated are effectively cached, whereby overloading of a network band is prevented, and a load on the content server 103 is distributed so as to maintain high service quality.

The outline of this embodiment will be described here. First, the Web server 102-1 creates a feed from an HTML document concerning the Web site as is stored in the storage unit, and it transmits the feed to the cache control apparatus 101 (1). Thereafter, the cache control apparatus 101 receives the feed from the Web server 102-1, and it calculates the number of subscribers to the feed, for every ISP.

On this occasion, in a case where the number of subscribers to the feed, as to each individual ISP has become a preset threshold value or larger, an instruction for caching a rich content specified from the feed is transmitted to the cache server 104-1 (2). Here will be exemplified the case where the number of the subscribers of “mifty” (ISP name) has become the threshold value or larger.

Upon receiving the cache instruction from the cache control apparatus 101, the cache server 104-1 designates the URL of the rich content contained in the cache instruction and transmits a request for acquiring the rich content, to the content server 103 (3).

Upon receiving the rich content acquisition request from the cache server 104-1, the content server 103 extracts the rich content complying with the acquisition request, from the storage unit, and it transmits the rich content to the cache server 104-1 (4). As a result, the cache server 104-1 receives the rich content from the content server 103 and caches this rich content thereinto.

Thereafter, the cache control apparatus 101 delivers the feed to any of the client terminals 105-1 to 105-n corresponding to the subscriber (5). Incidentally, the delivery timing of the feed may be, for example, after the cache instruction for the rich content has been transmitted, or after the notice of the completion of the caching of the rich content has been received from the corresponding one of the cache servers 104-1 to 104-n.

### (Stored Contents of Databases)

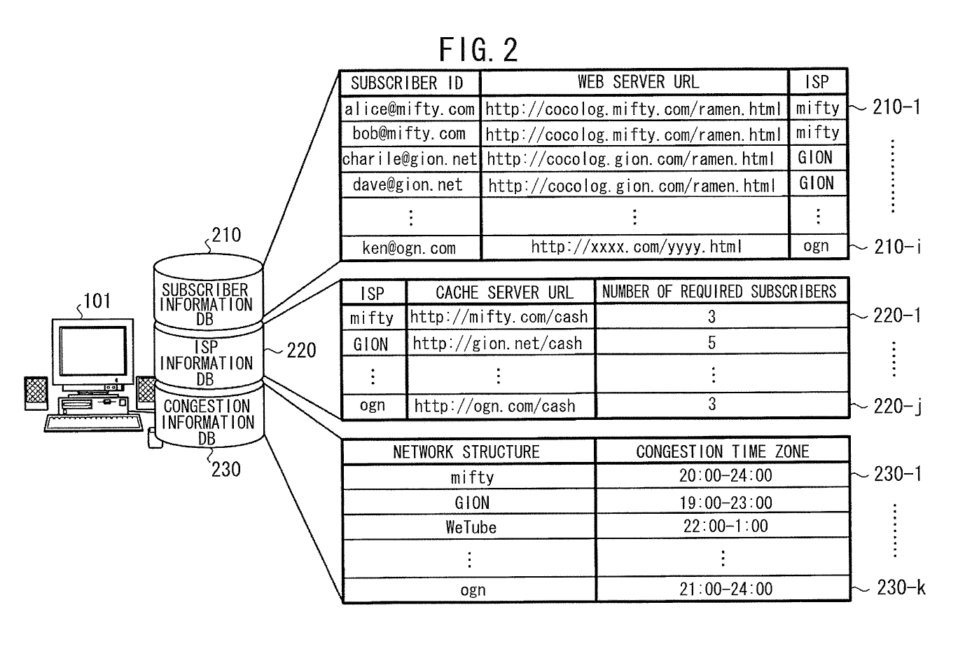

Next, there will be described the stored contents of databases which are included in the computer apparatuses shown in FIG. 1. First, there will be described the stored contents of the databases included in the cache control apparatus 101. FIG. 2 is an explanatory diagram showing the stored contents of the databases included in the cache control apparatus 101. Referring to FIG. 2, the cache control apparatus 101 includes the subscriber information DB 210, the ISP information DB 220, and the congestion information DB 230.

### (Stored Contents of Subscriber Information DB)

The subscriber information DB 210 stores therein the subscriber information items 210-1 to 210-i of respective subscribers who subscribe to feeds. Concretely, each of the subscriber information items 210-1 to 210-i has information items about a subscriber ID, a Web server URL and the ISP name of every subscriber. The subscriber ID is identification information for specifying the subscriber of the feed. The Web server URL is the URL of each of the Web servers 102-1 to 102-n which are the creation sources of the feeds. The ISP name is the appellation of the ISP with which the subscriber has made a contract.

Here, when the subscriber information 210-1 is mentioned as an example, it indicates the URL “http://cocolog.mifty.com/ramen.html” of any of the Web servers 102-1 to 102-n as is the creation source of the feed to which the subscriber specified from the subscriber ID “alice@mifty.com” subscribes, and the appellation “mifty” of the ISP with which the subscriber has made the contract. The stored contents of the subscriber information DB 210 are utilized for calculating the numbers of the subscribers to the feeds.

### (Stored Contents of ISP Information DB)

The ISP information DB 220 stores the ISP information items 220-1 to 220-j of the respective ISPs therein. Concretely, each of the ISP information items 220-1 to 220-j has information items about the ISP name, a cache server URL and the number of required subscribers of every ISP. The ISP name is the appellation of the ISP. The cache server URL is the URL of each of the cache servers 104-1 to 104-n operated by the ISP. The number of required subscribers is the number of subscribers to the feed for which the rich content needs to be cached.

Here, when the ISP information 220-1 is mentioned as an example, it indicates the URL “http://mifty.com/cash” of the cache server 104-1 which is operated by the ISP having the ISP name of “mifty”, and the number of required subscribers is “3”. The stored contents of the ISP information DB 220 are utilized for judging whether or not the rich contents are to be cached.

### (Stored Contents of Congestion Information DB)

The congestion information DB 230 stores the congestion information items 230-1 to 230-k of respective network structures therein. Concretely, each of the congestion information items 230-1 to 230-k has information for specifying a time zone in which a communication traffic within a corresponding network increases, for every network structure. The “network structure” signifies, for example, a communication network which is used by each individual ISP, or a communication network which is used by a delivery server (for example, the content server 103).

Here, when the congestion information 230-1 is mentioned as an example, it indicates the time zone “20:00-24:00” in which the communication traffic within the network of the ISP having the ISP name of “mifty” increases. The stored contents of the congestion information DB 230 are utilized for judging the transmission timings of cache instructions.

### (Stored Contents of Cache Information DB)

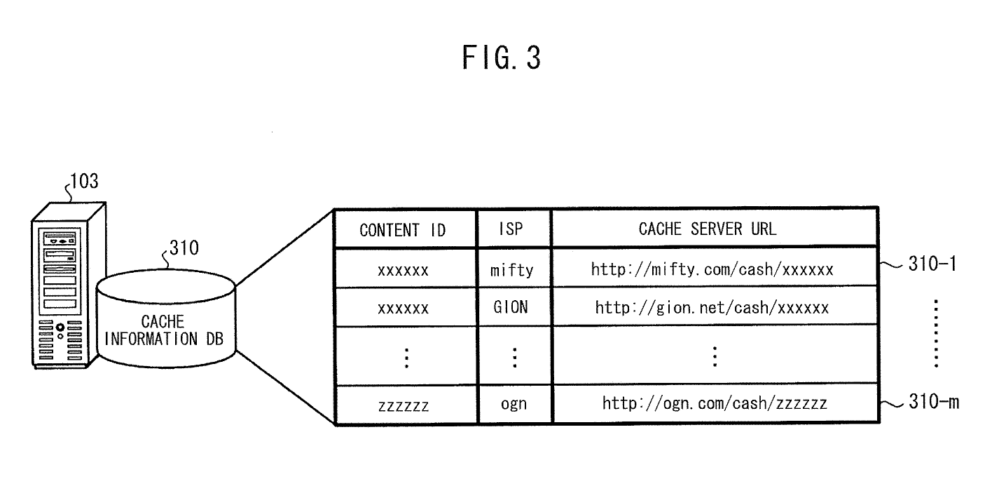

Next, there will be described the stored contents of a database which is included in the content server 103. FIG. 3 is an explanatory diagram showing the stored contents of the cache information DB 310 included in the content server 103. Referring to FIG. 3, the cache information DB 310 stores the cache information items 310-1 to 310-m of respective contents therein.

Concretely, each of the cache information items 310-1 to 310-m has information items about a content ID, the ISP name and the cache server URL, for every content. The content ID is identification information for specifying the content. The ISP name is the appellation of the ISP. The cache server URL is the URL of each of the rich contents which are cached in the cache servers 104-1 to 104-n operated by the respective ISPs.

Here, when the cache information 310-1 is mentioned as an example, it indicates the URL “http://mifty.com/cash/xxxxxx” of the rich content which is specified from the content ID “xxxxxx” that is cached in the cache server 104-1 operated by the ISP having the ISP name “mifty”.

### (Hardware Configuration of Computer Apparatus)

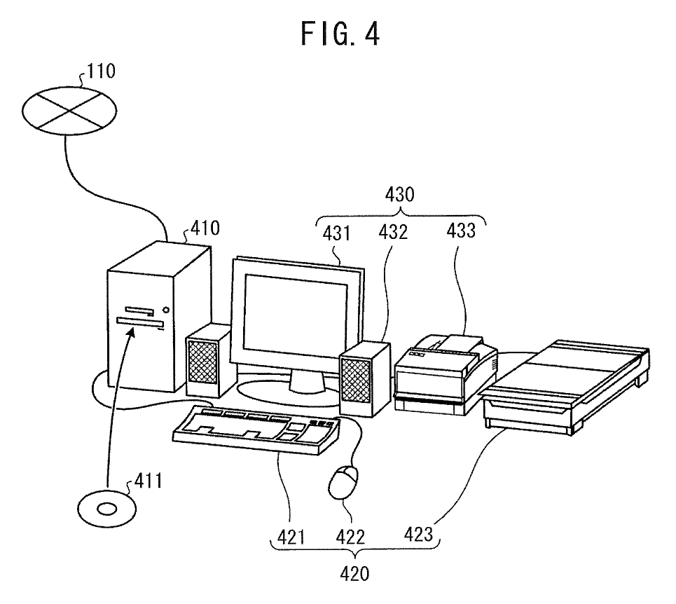

Next, there will be described the hardware configuration of each of the computer apparatuses (the cache control apparatus 101, the Web servers 102-1 to 102-n, the content server 103, the cache servers 104-1 to 104-n, and the client terminals 105-1 to 105-n) shown in FIG. 1. FIG. 4 is an explanatory diagram showing the hardware configuration of the computer apparatus according to one embodiment of this invention.

Referring to FIG. 4, the computer apparatus is configured of the computer proper 410, input devices 420 and output devices 430, and it is connectable to the network 110 such as LAN, WAN or Internet, through a router or a modem not shown.

The computer proper 410 includes a CPU, memories and interfaces. The CPU governs the control of the whole computer apparatus. The memories consist of a ROM, a RAM, an HD, an optical disk 411 and a flash memory. The memories are used as the work areas of the CPU.

Besides, various programs are stored in the memories, and they are loaded in compliance with instructions from the CPU. The HD and the optical disk 411 have data read/write operations controlled by disk drives. The optical disk 411 and the flash memory are detachably attached to the computer proper 410. The interfaces perform input operations from the input devices 420, output operations to the output devices 430, and the controls of transmission and reception to and from the network 110.

The input devices 420 include, for example, a keyboard 421, a mouse 422 and a scanner 423. The keyboard 421 includes keys for inputting characters, numerals, various instructions, etc., and it inputs data. The keyboard 421 may well be replaced with a touch panel type device. The mouse 422 performs the movement of a cursor and the selection of a range, the movement of a window and the alteration of a size, etc. The scanner 423 optically reads an image. The read image is accepted as image data, which are stored in the memory within the computer proper 410. Incidentally, the scanner 423 may have an OCR function.

Besides, the output devices 430 include, for example, a display 431, loudspeakers 432 and a printer 433. The display 431 displays the cursor, icons and a tool box, and also the data of a document, the image, functional information, etc. The printer 433 prints the image data and the document data. Further, the loudspeakers 432 output sound such as effect sound or reading-out voice.

### (Functional Configuration of Content Delivery System)

Next, there will be described the functional configuration of the content delivery system 100 shown in FIG. 1. FIG. 5 is a block diagram showing the functional configuration of the content delivery system 100. First, there will be described the functional configuration of the cache control apparatus 101. Referring to FIG. 5, the cache control apparatus 101 includes a reception unit 501, a judgment unit 502, a detection unit 503, an extraction unit 504, a transmission unit 505 and a delivery unit 506.

The functions 501 to 506 can be incarnated by causing the CPU to run programs concerning these functions 501 to 506 as are stored in the storage unit of the cache control apparatus 101, or they can be incarnated by input/output I/Fs. Besides, output data from the functions 501 to 506 are retained in the storage unit. Further, the functions of connection destinations indicated by arrows in FIG. 5 are such that output data from the functions of connection sources are fetched from the storage unit, so that the CPU is caused to run programs concerning the functions of the connection destinations.

First, the reception unit 501 has the function of receiving a feed which concerns any desired site. The reception unit 501 receives the feed from, for example, any of the Web servers 102-1 to 102-n (hereinbelow, expressed as the “Web server 102”). The “feed” signifies electronic data (for example, an XML document) which represent the summary of the Web site of a blog (Web blog), a news site or the like. A format for describing the feed is, for example, RSS (Rich Site Summary) or Atom.

In general, a site is registered in a feed reader in such a way that a user clicks an icon indicating a link to the feed as is arranged in the site. As a result, the update of the feed for which the feed reader has been registered is periodically checked, and the user is informed of the update. That is, the user can know the update timing of the desired site by registering the site in the feed reader.

The judgment unit 502 has the function of judging whether or not a rich content specified from the feed, among contents stored in the first server, is cached, on the basis of the number of subscribers to the feed as has been received by the reception unit 501. The subscribers are users who subscribe to the feed. The first server is, for example, the content server 103. Incidentally, the subscription to the feed may be either paid or free of charge.

Here, the “rich content” may be, for example, a content of large data quantity, such as an image or music, or a content which contains a news item concerning a sportplayer, an entertainer other well-known person as is anticipated to arouse users' high interest. More concretely, the “rich content” may be, for example, a content which exceeds a selected data quantity, or a content which contains a selected keyword. A content of a specified sort may well be set as the rich content, as well.

Concretely, the judgment unit 502 may well judge that the rich content needs to be cached, if the number of subscribers to the feed is equal to or larger than a preset threshold value. The threshold value can be set at will, and it may well be set in such a way, for example, that the user manipulates the input device 420 such as the keyboard 421 or mouse 422 shown in FIG. 4. More concretely, the threshold value is, for example, the number of required subscribers of each individual ISP as is stored in the ISP information DB 220 shown in FIG. 2.

The number of required subscribers is calculated on the basis of, for example, the expected value of the number of download times of the rich content. Here, in a case where the expected value of the number of download times of the rich content has exceeded “1”, it is judged that the rich content needs to be cached. The “expected value” can be obtained from, for example, “(expected value of the number of download times of the rich content)=(number of subscribers to the feed)×(Web reference rate)×(download rate)”.

Here, the “Web reference rate” is a rate at which the subscribers to the feed refer to the Web contents of the Web server 102 that is the creation source of the feed, by actually using a Web browser. The “download rate” is the click rate of the link to the rich content on the Web contents. Assuming, for example, that the Web reference rate is “0.5” and that the download rate is “0.4”, the expected value exceeds “1” in a case where the number of subscribers to the feed is larger than “5”, so that the above number of required subscribers is set at “6”.

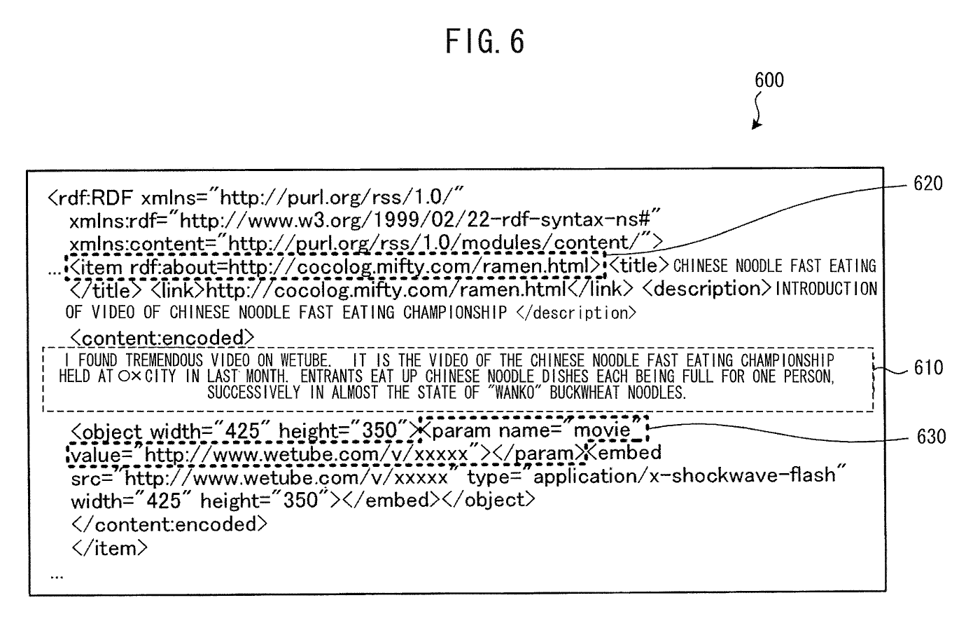

A judgment process based on the judgment unit 502 will be described here. The detection unit 503 has the function of detecting the URL of the Web server 102 which is the creation source of the feed, from among feeds received by the reception unit 501. FIG. 6 is an explanatory diagram showing a practical example of the feed. Referring to FIG. 6, the feed 600 is electronic data representing the summary of a Web site, and it is described in the language of the XML (Extensible Markup Language).

More specifically, HTML data representing the summary of the Web site are inserted in an insertion position 610 within the feed 600. The URL of the Web server 102, being the creation source of the feed 600, is inserted in an insertion position 620. Further, the URL of a rich content is inserted in an insertion position 630. In a case, for example, where the feed 600 has been received by the reception unit 501, the detection unit 503 detects the URL “http://cocolog.mifty.com/ramen.html” of the Web server 102 as is inserted in the insertion position 620, from within the feed 600.

The detection unit 503 has the function of detecting the URL of the rich content from within the feed received by the reception unit 501. The “URL of the rich content” is a URL from which the rich content can be downloaded by, for example, designating this URL. Here, in the case where the feed 600 has been received by the reception unit 501, the detection unit 503 detects the URL “http://www.wetube.com/v/xxxxx” of the rich content as is inserted in the insertion position 630, from within the feed 600.

More concretely, by way of example, the detection unit 503 may well judge the sort of the content from a character string such as “param name=“movie””, inserted in the insertion position 630, and then detect the URL “http://www.wetube.com/v/xxxxx” in a case where the sort is one (for example, “movie”) set for the rich content beforehand.

The extraction unit 504 has the function of extracting subscriber IDs stored in association with the URL of the Web server 102 detected by the detection unit 503, from within the subscriber information DB 210 in which the URLs of the creation sources of feeds and subscriber IDs are stored in association. By way of example, the subscriber information items 210-1 to 210-n of subscribers as are stored in association with the URL of the Web server 102 detected by the detection unit 503 are extracted from within the subscriber information DB 210.

The judgment unit 502 judges the number of subscribers to the feed received by the reception unit 501, on the basis of the subscriber IDs extracted by the extraction unit 504. In a case, for example, where the subscriber information items 210-1 to 210-4 have been extracted by the extraction unit 504, the number of subscribers to the feed is judged as “4” from the subscriber IDs contained in the subscriber information items 210-1 to 210-4.

Thereafter, the judgment unit 502 judges that the rich content needs to be cached, if the number of subscribers to the feed is equal to or larger than a preset threshold value. In a case, for example, where the preset threshold value is “3”, the judgment unit 502 judges that the rich content needs to be cached, because the number of subscribers to the feed is “4” in the above example.

Alternatively, the judgment unit 502 may well judge that the rich content needs to be cached for the second server operated by an ISP, in a case where the number of subscribers of each ISP is equal to or larger than a preset threshold value, on the basis of the numbers of subscribers of respective ISPs which the subscribers to the feed utilize. The number of subscribers of each ISP can be judged from, for example, extraction results extracted by the extraction unit 504.

In the case, for example, where the subscriber information items 210-1 to 210-4 have been extracted by the extraction unit 504, the numbers of subscribers of the respective ISPs are judged from ISP names contained in the subscriber information items 210-1 to 210-4. Here, from the ISP names (“mifty” and “GION”) contained in the subscriber information items 210-1 to 210-4, it is judged that the number of subscribers of the ISP having the ISP name “mifty” is “2”, and that the number of subscribers of the ISP having the ISP name “GION” is “2”.

Thereafter, in a case where the numbers of subscribers of the respective ISPs are equal to or larger than the numbers of required subscribers of the ISPs, the judgment unit 502 judges that the rich content needs to be cached for the cache servers 104-1 to 104-n (hereinbelow, expressed as the “cache server 104”) operated by the ISPs. The numbers of required subscribers of the ISPs can be judged from, for example, the ISP information items 220-1 and 220-2 stored in the ISP information DB 220.

By way of example, the extraction unit 504 extracts the ISP information items 220-1 and 220-2 from the ISP information DB 220, on the basis of the ISP names contained in the subscriber information items 210-1 to 210-4. In addition, the judgment unit 502 judges the numbers of required subscribers of the respective ISPs, from the ISP information items 220-1 and 220-2 extracted by the extraction unit 504.

Here, the numbers of required subscribers of the respective ISPs having the ISP names “mifty” and “GION” are judged to be “3” and “5”, from the ISP information items 220-1 and 220-2. In this case, the judgment unit 502 judges that the rich content need not be cached, because the numbers of subscribers of the ISPs having the ISP names “mifty” and “GION” are “2”, respectively, so both are less than the numbers of required subscribers.

Incidentally, the judgment process based on the judgment unit 502 may well be omitted in a case where the URL of the rich content has not been detected from within the feed by the detection unit 503. This is because, even when the feed has been delivered to the subscriber, there is the low possibility that an access to the rich content of large data quantity will occur with the feed delivery as a trigger.

The transmission unit 505 has the function of transmitting a cache instruction for the rich content, to the second server which accepts a transmission request for the rich content from the terminal apparatus of the subscriber, in a case where the caching of the rich content has been judged necessary by the judgment unit 502. The “cache instruction” is electronic data representing the URL of the rich content, and it is, for example, the URL inserted in the insertion position 630 within the feed 600.

Besides, information representing the number of subscribers to the feed may well be contained in the cache instruction. The number of subscribers to the feed is judged from the subscriber information items 210-1 to 210-n as stated above. The “terminal apparatus of the subscriber” is, for example, each of the client terminals 105-1 to 105-n (hereinbelow, expressed as the “client terminal 105”). The “transmission request for the rich content” is, for example, a download request for the rich content as is specified from the feed.

Besides, the “second server” is, for example, the cache server 104 within the network to which the client terminal 105 of the subscriber belongs, more specifically, the cache server 104 operated by the ISP with which the subscriber has made a contract. In the example shown in FIG. 1, the “second server” is the cache server 104-1 operated by that ISP of the ISP name “mifty” with which the subscribers of the client terminals 105-1 and 105-2 have made contracts.

Further, the transmission unit 505 may well transmit the cache instruction for the rich content to the second server, prior to the delivery of the feed to the terminal apparatus. That is, the cache instruction for the rich content is transmitted before the access from the subscriber to the rich content occurs.

Still further, the transmission unit 505 may well transmit the cache instruction to the second server in another time zone different from the congestion time zone, on the basis of the congestion information for specifying the time zone when the communication traffic within the network to which the client apparatus belongs increases. That is, the cache instruction for the rich content is transmitted by avoiding the time zone in which the communication traffic increases, thereby to prevent overload of a network band, etc.

By way of example, the extraction unit 504 extracts from the congestion information DB 230 the congestion information items 230-1 to 230-k within the network to which the client terminal 105 belongs. The transmission unit 505 specifies the congestion time zone from the congestion information items 230-1 to 230-k extracted by the extraction unit 504, and it transmits the cache instruction to the cache server 104 in another time zone different from the congestion time zone.

More concretely, in a case, for example, where the congestion information 230-1 within the network to which the client terminal 105-1 belongs has been extracted, the cache instruction is transmitted to the cache server 104-1 in another time zone different from the congestion time zone “20:00-24:00” which is specified from the congestion information 230-1.

The delivery unit 506 has the function of transmitting the feed to the terminal apparatus of the subscriber as the result of the transmission of the cache instruction by the transmission unit 505. The subscriber to the delivery destination of the feed is specified from, for example, the subscriber information items 210-1 to 210-n extracted from within the subscriber information DB 210 by the extraction unit 504.

The delivery unit 506 may well transmit the feed to the terminal apparatus of the subscriber in a case where a completion notice representing the completion of the caching of the rich content has been received from the cache server 104 to which the cache instruction has been transmitted by the transmission unit 505. Thus, the rich content can be reliably cached before the access from the subscriber to the rich content occurs.

Next, there will be described the functional configuration of the cache server 104. Referring to FIG. 5, the cache server 104 includes a reception unit 511, a transmission unit 512, an extraction unit 513, a decision unit 514 and a deletion unit 515.

The functions 511 to 515 can be incarnated by causing the CPU to run programs concerning these functions 511 to 515 as are stored in the storage unit of the cache server 104, or they can be incarnated by input/output I/Fs. Output data from the functions 511 to 515 are retained in the storage unit. Further, the functions of connection destinations indicated by arrows in FIG. 5 are such that output data from the functions of connection sources are fetched from the storage unit, and the CPU is caused to run programs concerning the functions of the connection destinations.

First, the reception unit 511 has the function of receiving the cache instruction for the rich content from the cache control apparatus 101 which controls the caching of the rich content specified from the feed. The “cache instruction for the rich content” is electronic data which contains, for example, the URL of the rich content. The cache instruction may also contain information which represents the number of subscribers of the feed.

The transmission unit 512 has the function of transmitting an acquisition request for the rich content to the first server in which the rich content is stored and which is specified from the cache instruction for the rich content, in a case where the cache instruction for the rich content has been received by the reception unit 511. Concretely, by way of example, the transmission unit 512 designates the URL of the rich content as is contained in the cache instruction, and it transmits the acquisition request for the rich content to the content server 103.

The reception unit 511 has the function of receiving the rich content from the first server, as the result of the transmission of the acquisition request for the rich content by the transmission unit 512. The rich content received by the reception unit 511 is cached into the cache DB 520. As a result, the client terminal 105 can acquire the rich content from the cache server 104.

Further, the reception unit 511 has the function of receiving a transmission request for the rich content from the terminal apparatus of the subscriber to the feed. The “transmission request for the rich content” is electronic data representing, for example, the content ID of the rich content as is specified from the feed.

The extraction unit 513 has the function of extracting the rich content specified from the transmission request received by the reception unit 511, from among a group of cached contents (in, for example, the cache DB 520). Besides, the transmission unit 512 has the function of transmitting the rich content extracted by the extraction unit 513, to the terminal apparatus which is the transmission source of the transmission request.

The decision unit 514 has the function of deciding whether or not the number of times of transmission of the rich content by the transmission unit 512 has become equal to or larger than a predetermined number of times. The predetermined number of times can be set at will. Specifically, by way of example, the number of subscribers to the feed as is specified from the cache instruction received by the reception unit 511 may well be set as the predetermined number of times.

The deletion unit 515 has the function of deleting the rich content among the group of cached contents, in a case where it has been decided by the decision unit 514 that the number of times of transmission of the rich content is equal to or larger than the predetermined number of times. Concretely, by way of example, the rich content may well be deleted from within the cache DB 520, in a case where the number of times of transmission of the rich content has been decided to be equal to or larger than the number of subscribers to the feed.

Besides, in a case where the rich content has been deleted from within the cache DB 520 by the deletion unit 515, the transmission unit 512 transmits to the content server 103 a deletion notice which represents the deletion of the rich content. In a case where the content server 103 has received the deletion notice from the cache server 104, it deletes from the cache information DB 310 any of the cache information items 310-1 to 310-m as are specified from the deletion notice.

Here will be described a series of flows in which the client terminal 105 acquires the rich content from the cache server 104. First, the client terminal 105 receives the feed which is delivered from the cache control apparatus 101. By way of example, the client terminal 105 periodically transmits a delivery request for the feed to the cache control apparatus 101, with the result that it receives the feed from the cache control apparatus 101.

Thereafter, the client terminal 105 activates a Web browser, and it designates that URL of the Web server 102 which is inserted in the feed, thereby to access a Web site. On this occasion, in a case where a link to the rich content is contained, the user clicks the link, whereby the client terminal 105 can be connected to the content server 103 in which the rich content is stored.

Concretely, by way of example, a request which contains the content ID for specifying the rich content and the contract ISP information for specifying the ISP where the client terminal 105 belongs is transmitted from the client terminal 105 to the content server 103. When the content server 103 receives the request from the client terminal 105, it judges the existence or nonexistence of the caching of the rich content specified from the content ID.

Concretely, by way of example, the content server 103 judges whether or not the rich content specified from the content ID is cached in the cache server 104 operated by the ISP specified from the contract ISP information, on the basis of the cache information items 310-1 to 310-m stored in the cache information DB 310 shown in FIG. 3. In a case, for example, where the ISP specified from the contract ISP information is “mifty”, it can be judged that the rich content is cached, on the basis of the cache information 310-1.

Subject to the judgment that the rich content has already been cached, the content server 103 transmits to the client terminal 105 a transfer instruction which contains a URL for acquiring the rich content from the cache server 104 that is operated by the ISP specified from the contract ISP information. Concretely, by way of example, the content server 103 transmits to the client terminal 105 a transfer instruction which contains the cache server URL “http://mifty.com/cash/xxxxxx” specified from the cache information 310-1.

Thereafter, in a case where the client terminal 105 has received the transfer instruction from the content server 103, it designates the URL contained in the transfer instruction, thereby to transmit the acquisition request for the rich content to the cache server 104.

In a case where the cache server 104 has received the acquisition request from the client terminal 105, it extracts the rich content complying with the acquisition request, from the cache DB 520, and it transmits the extracted rich content to the client terminal 105. As a result, the client terminal 105 receives the rich content from the cache server 104.

On this occasion, the cache server 104 counts the number of times of transmission of the rich content to the client terminal 105. In a case where the count number has become equal to or larger than the number of subscribers to the feed, the cache server 104 deletes the rich content from within the cache DB 520. That is, the rich content as to which the future increase of accesses is not anticipated is deleted from within the cache DB 520.

Incidentally, the decision process based on the decision unit 514 and the deletion process based on the deletion unit 515 may well be executed for every ISP. That is, in a case where the number of times of transmission of the rich content has become equal to or larger than the number of the feed subscribers of each ISP, the rich content cached in the cache server 104 operated by the ISP is deleted. Incidentally, information for specifying the number of the feed subscribers of each ISP is contained in, for example, the cache instruction for the rich content.

### (Cache Control Processing Procedure of Cache Control Apparatus)

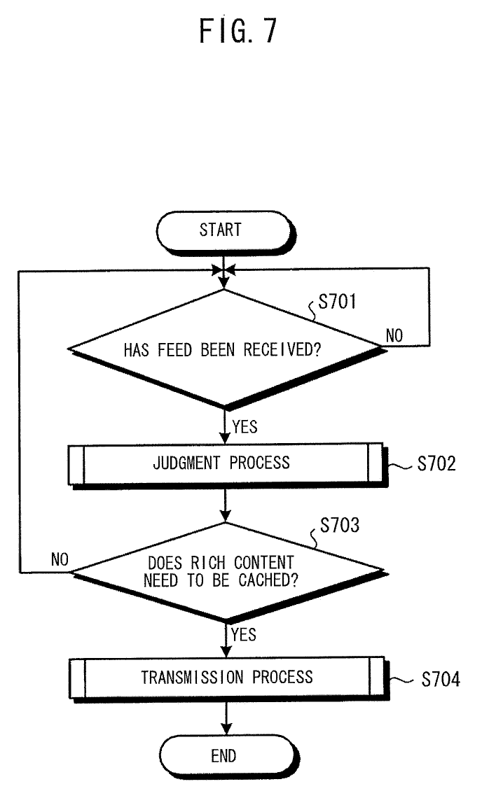

Next, there will be described the cache control processing procedure of the cache control apparatus 101 according to one embodiment of this invention. FIG. 7 is a flow chart showing the cache control processing procedure of the cache control apparatus according to this embodiment. Referring to the flow chart of FIG. 7, whether or not a feed concerning any desired site has been received is first judged by the reception unit 501 (step S701).

Here, the reception of the feed is waited for (step S701: “No”). In a case where the feed has been received (step S701: “Yes”), the judgment unit 502 executes a judgment process for judging whether or not a rich content specified from the feed, among contents stored in the first server is cached, on the basis of the number of subscribers to the feed received by the reception unit 501 (step S702).

Thereafter, whether or not the rich content needs to be cached is judged from the judgment result of the judgment unit 502 (step S703). In a case where the rich content needs to be cached (step S703: “Yes”), the transmission process 505 executes a transmission process in which a cache instruction for the rich content is transmitted to the second server that accepts a transmission request for the rich content from the terminal apparatus of a subscriber to the feed (step S704). Then, the series of processing steps based on this flow chart is ended. Besides, in a case where the rich content need not be cached at the step S703 (step S703: “No”), the routine returns to the step S701, and the series of processing steps are repeated.

Thus, rich contents as to which the future increases of accesses are anticipated can be effectively cached.

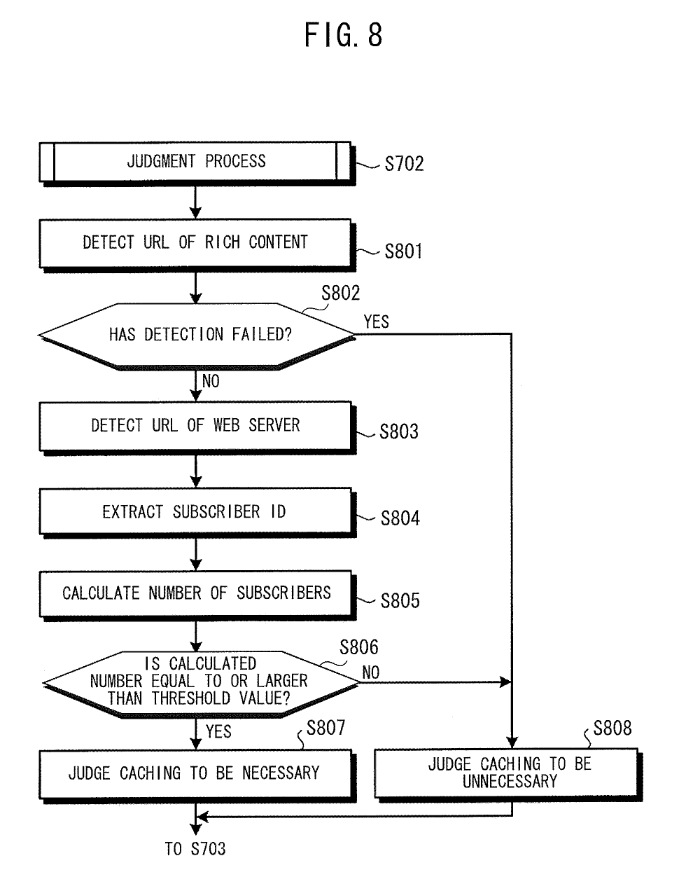

Next, there will be described the processing procedure of the judgment process at the step S702 shown in FIG. 7. FIG. 8 is a flow chart showing an example of the processing procedure of the judgment process. Referring to the flow chart of FIG. 8, the URL of the rich content is first detected from within the feed received at the step S701 shown in FIG. 7, by the detection unit 503 (step S801).

Thereafter, whether or not the URL of the rich content has been detected is judged (step S802). In a case where the URL of the rich content has been detected (step S802: “No”), the URL of the Web server 102 being the creation source of the feed is detected from within the feed, by the detection unit 503 (step S803).

In addition, a subscriber ID which is stored in association with the URL of the Web server 102 as has been detected by the detection unit 503 is extracted from within the subscriber information DB 210 by the extraction unit 504 (step S804). Thereafter, the judgment unit 502 calculates the number of subscribers to the feed, on the basis of the subscriber IDs extracted by the extraction unit 504 (step S805).

Thereafter, the judgment unit 502 judges whether or not the calculated number of subscribers to the feed is, at least, equal to a preset threshold value (step S806). Here, in a case where the number of subscribers to the feed is equal to or larger than the threshold value (step S806: “Yes”), it is judged by the judgment unit 502 that the rich content needs to be cached (step S807), and the routine shifts to the step S703 shown in FIG. 7.

Besides, in a case where the URL of the rich content has not been detected at the step S802 (step S802: “Yes”), or where the number of subscribers to the feed has been less than the preset value at the step S806 (step S806: “No”), it is judged by the judgment unit 502 that the rich content need not be cached (step S808), and the routine shifts to the step S703 shown in FIG. 7.

Thus, whether or not the rich content needs to be cached into the cache server operated by the ISP can be judged in accordance with the number of the feed subscribers of each ISP.

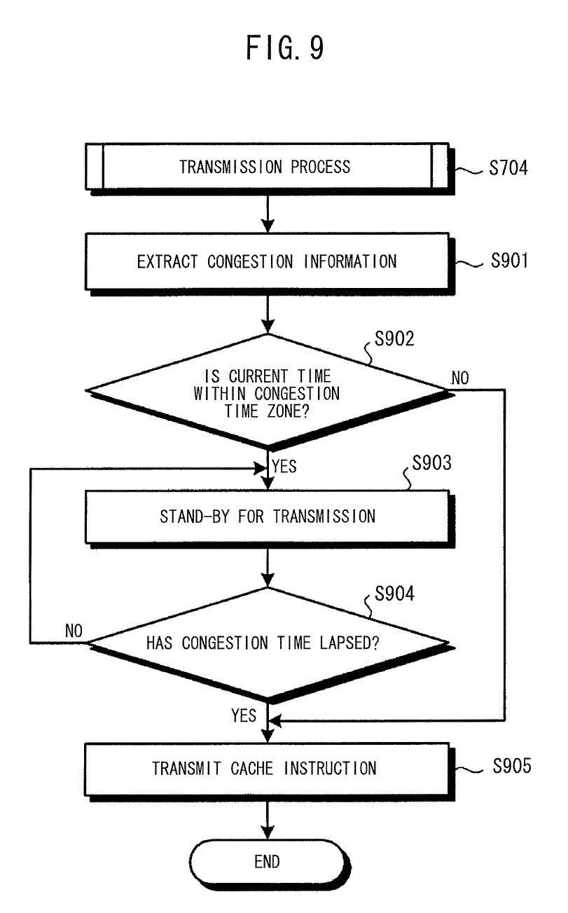

Next, there will be described the processing procedure of the transmission process at the step S704 shown in FIG. 7. FIG. 9 is a flow chart showing an example of the processing procedure of the transmission process. Referring to the flow chart of FIG. 9, any of the congestion information items 230-1 to 230-k in the network to which the client terminal 105 belongs is first extracted from the congestion information DB 230 by the extraction unit 504 (step S901).

Thereafter, whether or not the current time is within a congestion time zone specified from the extracted one of the congestion information items 230-1 to 230-k is judged (step S902). Here, in a case where the current time is within the congestion time zone (step S902: “Yes”), the state of transmission standby for a cache instruction begins (step S903).

Here, the lapse of a congestion time is waited for (step S904: “No”). In a case where the congestion time has lapsed (step S904: “Yes”), the cache control apparatus 101 is reset from the transmission standby state, and the cache instruction for the rich content is transmitted to the cache server 104 by the transmission unit 505 (step S905). In a case where the current time is not within the congestion time zone at the step S902 (step S902: “No”), the routine shifts to the step S905.

Thus, the cache instruction for the rich content can be transmitted by avoiding the time zone in which a communication traffic increases.

### (Deletion Processing Procedure of Cache Server)

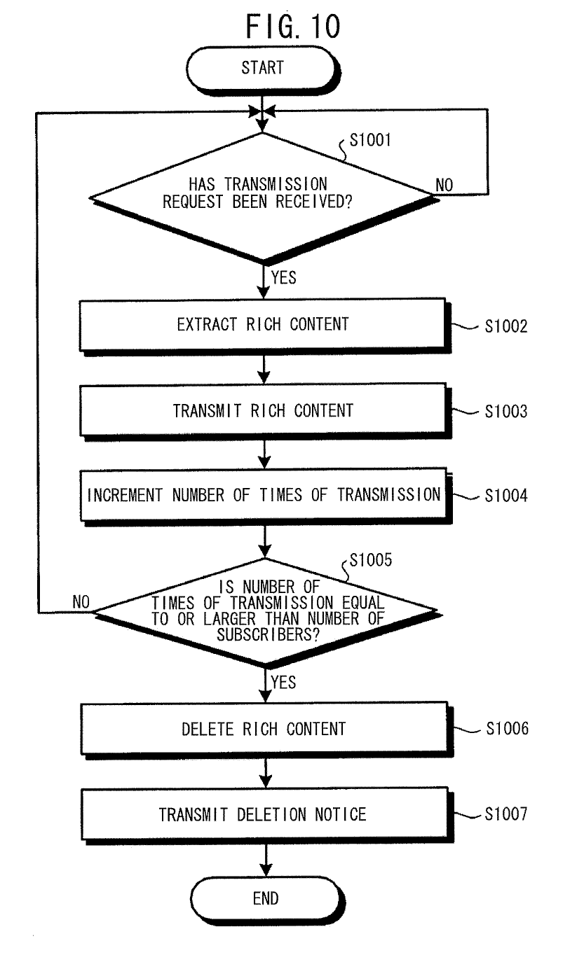

Next, there will be described the procedure of a deletion process for the cached rich content in the cache server 104 according to one embodiment of this invention. FIG. 10 is a flow chart showing an example of the deletion processing procedure of the cache server according to this embodiment. Referring to the flow chart of FIG. 10, whether or not a transmission request for the rich content has been received from the client terminal 105 of the subscriber to the feed is first judged by the reception unit 511 (step S1001).

Here, the reception of the transmission request for the rich content is waited for (step S1001: “No”). In a case where the transmission request has been received (step S1001: “Yes”), the rich content specified from the transmission request received by the reception unit 511 is extracted from within the cache DB 520 by the extraction unit 513 (step S1002).

Thereafter, the rich content extracted by the extraction unit 513 is transmitted to the client terminal 105 being the transmission source of the transmission request, by the transmission unit 512 (step S1003). Here, the number of times of transmission of the rich content by the transmission unit 512 is incremented as the result of the transmission of the rich content by the transmission unit 512 (step S1004).

Thereafter, whether or not the number of times of transmission of the rich content by the transmission unit 512 has become equal to or larger than the number of subscribers is decided by the decision unit 514 (step S1005). Here, in a case where the number of times of transmission of the rich content is equal to or larger than the number of subscribers (step S1005: “Yes”), the rich content is deleted from within the cache DB 520 by the deletion unit 515 (step S1006).

Lastly, a deletion notice representing that the rich content has been deleted from within the cache DB 520 is transmitted to the content server 103 by the transmission unit 512 (step S1007). Then, the series of processing steps based on this flow chart are ended. Besides, in a case where the number of times of transmission of the rich content is less than the number of subscribers at the step S1005 (step S1005: “No”), the routine returns to the step S1001, and the series of processing steps are repeated.

Thus, rich contents as to which the future increase of accesses is not anticipated can be deleted from within the cache DB 520.

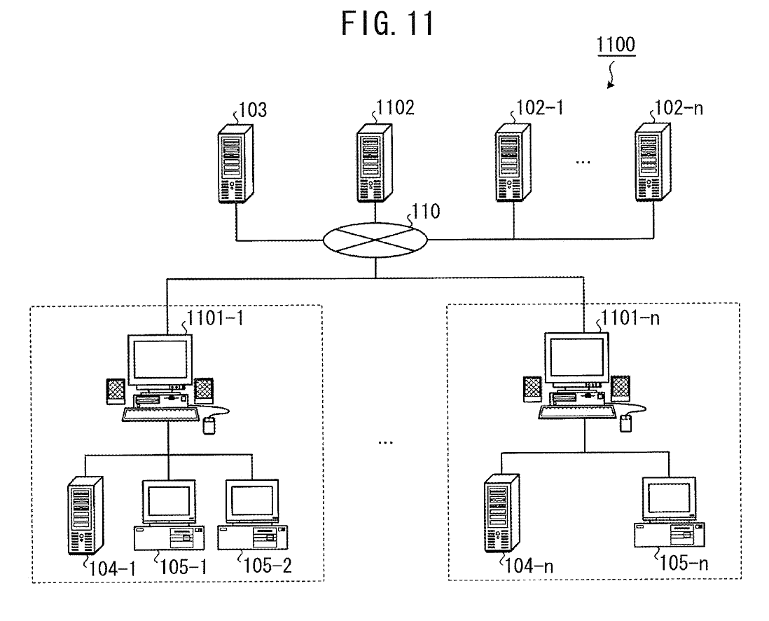

By the way, in this embodiment, the cache control apparatus 101 has been applied to the computer apparatus which delivers the feeds, but this is not restrictive. By way of example, cache control apparatuses 101 may well be applied to gateway apparatuses which are prepared for the respective ISPs. FIG. 11 is an explanatory diagram showing another system configuration of a content delivery system.

Referring to FIG. 11, the content delivery system 1100 is such that the gateway apparatuses 1101-1 to 1101-n, a feed delivery server 1102, Web servers 102-1 to 102-n, a content server 103, cache servers 104-1 to 104-n, and client terminals 105-1 to 105-n are connected through a network 110 such as the Internet, a LAN or a WAN, in a manner to be communicable with one another.

The gateway apparatuses 1101-1 to 1101-n are computer apparatuses which have the functions of controlling the caching of rich contents into the respective cache servers 104-1 to 104-n. Besides, the gateway apparatuses 1101-1 to 1101-n have the functions of permitting the communications between networks which use different media or communication protocols.

The feed delivery server 1102 has the functions of receiving feeds from the Web servers 102-1 to 102-n, and delivering the feeds to the gateway apparatuses 1101-1 to 1101-n or the client terminals 105-1 to 105-n of subscribers.

Here, the cache controls of the respective ISPs are incarnated by the gateway apparatuses 1101-1 to 1101-n which manage the communications of the client terminals 105-1 to 105-n belonging to the corresponding ISPs. Thus, the cache controls in the networks of the plurality of ISPs need not be collectively performed, and a load on the cache control apparatus 101 can be lightened.

Concretely, it is dispensed with to execute, for example, calculation processes for obtaining the numbers of subscribers to the feeds, for the respective ISPs, and transmission processes for transmitting cache instructions for rich contents to the cache servers operated by the respective ISPs.

In this manner, according to this embodiment, the rich contents as to which the future increase of accesses is anticipated can be effectively cached before the accesses from the subscribers to the feeds occur. Concretely, it is possible to effectively cache contents as to which the future trend of viewing is difficult of prediction, for example, contents which are submitted to a video sharing site or the like.

Thus, the rich contents specified from the feeds can be downloaded from the cache servers 104, and the load of the content server 103 during the viewing of the rich contents by the subscribers to the feeds can be lightened.

Besides, the cache instruction for the rich content can be transmitted by avoiding the time zone in which the communication traffic increases. Thus, overload of a network band during the accesses to the rich content as occurs with feed delivery as a trigger is prevented, and the utilization efficiency of the network 110 in the content delivery system 100 or 1100 can be enhanced.

Further, in a case where the number of accesses to the rich content by subscribers to the feed has become equal to the number of the subscribers, the rich content can be deleted from within the cache DB 520. In this manner, the rich content as to which the future increase of accesses is not anticipated is deleted from within the cache DB 520, whereby the effective utilization of the storage area of the cache DB 520 can be attained.

As described above, according to a storage medium storing a cache control program therein, a cache control apparatus, and a cache control method, contents as to which the future increase of accesses is anticipated are effectively cached, whereby the enhancement of a communication quality can be attained.

Incidentally, the cache control method described in the embodiment can be incarnated in such a way that a program prepared beforehand is run by a computer such as personal computer or workstation. The program is stored in a computer-readable storage medium such as hard disk, flexible disk, CD-ROM, MO or DVD, and it is read out from the storage medium and is run by the computer. Besides, the program may well be in a transfer medium which can be distributed through a network such as the Internet.

What is claimed is:

1. A computer-readable storage medium storing a cache control program which causes a computer to execute:
receiving a feed that concerns any desired site;
judging whether or not a rich content specified from the feed among contents stored in a first server is cached, on the basis of the number of subscribers to the feed received; and
transmitting a cache instruction for the rich content, to a second server that accepts a transmission request for the rich content from a terminal apparatus of the subscriber, in a case where the judging has judged that the rich content needs to be cached.

2. A storage medium according to claim 1, wherein the transmitting transmits the cache instruction for the rich content to the second server, prior to delivery of the feed to the terminal apparatus.

3. A storage medium according to claim 2, wherein the transmitting transmits the cache instruction to the second server in another time zone different from a congestion time zone, on the basis of congestion information for specifying the congestion time zone in which a communication traffic in a network where the terminal apparatus belongs increases.

4. A storage medium according to claim 3, wherein the judging judges that the rich content needs to be cached, in a case where the number of subscribers to the feed is equal to or larger than a preset threshold value.

5. A storage medium according to claim 4, wherein the judging judges that the rich content needs to be cached into the second server operated by each Internet service provider, in a case where the number of subscribers is equal to or larger than a preset threshold value on the basis of the number of the subscribers of each of a plurality of Internet service providers utilized by the subscribers to the feed.

6. A cache control apparatus comprising:
reception unit receiving a feed which concerns any desired site;
judgment unit judging whether or not a rich content specified from the feed among contents stored in a first server is cached, on the basis of the number of subscribers to the feed received by said reception unit; and
transmission unit transmitting a cache instruction for the rich content, to a second server which accepts a transmission request for the rich content from a terminal apparatus of the subscriber, in a case where the judgment unit has judged that the rich content needs to be cached.

7. A cache server comprising:
reception unit receiving a cache instruction for a rich content, from a computer apparatus which controls caching of the rich content specified from a feed concerning any desired site; and
transmission unit transmitting an acquisition request for the rich content, to a server in which the rich content specified from the cache instruction is stored, in a case where the cache instruction has been received by said reception unit;
wherein said reception unit receives the rich content from the server as the result of the transmission of the acquisition request by said transmission unit.

8. A cache server according to claim 7, wherein:
said reception unit receives a transmission request for the rich content, from a terminal apparatus of a subscriber to the feed; and
said transmission unit transmits the rich content specified from the transmission request received by said reception unit, to the terminal apparatus.

9. A cache server according to claim 8, further comprising:
decision unit for deciding whether or not the number of times of transmission by the rich content by said transmission unit has become equal to or larger than the number of subscribers to the feed as is specified from the cache instruction received by said reception unit; and
deletion unit for deleting the rich content among a group of cached contents, in a case where said decision unit has decided that the number of times of transmission is equal to or larger than the number of subscribers to the feed.
